(19) United States
(12) Patent Application Publication
(10) Pub. No.: US 2019/0079511 A1
(43) Pub. Date: Mar. 14, 2019

(54) Methods and Systems for Rotor Anomaly Detection and Response

(71) Applicant: QUALCOMM Incorporated, San Diego, CA (US)

(72) Inventors: Ross Eric Kessler, Philadelphia, PA (US); Michael Joshua Shomin, Philadelphia, PA (US); Jonathan Paul Davis, Philadelphia, PA (US); Travis Van Schoyck, Lafayette Hill, PA (US); Daniel Warren Mellinger, III, Philadelphia, PA (US)

(21) Appl. No.: 15/701,812

(22) Filed: Sep. 12, 2017

(51) Int. Cl. G05D 1/00; B64C 39/02; G07C 5/08; G05D 1/08

(52) U.S. Cl. CPC G05D 1/0055; B64C 39/024; B64C 2201/108; G05D 1/0858; G07C 5/0816

(57) ABSTRACT

Various embodiments include methods for rotor anomaly detection and response for an aerial robotic vehicle. A processor of the aerial robotic vehicle may obtain data from a sensor onboard the aerial robotic vehicle configured to detect anomalies in rotors. The processor may determine whether an anomaly is detected in any rotor based on the obtained data and take an action in response to detecting an anomaly in one or more rotors. Examples of actions that may be taken in response to detecting a rotor anomaly include preventing the aerial robotic vehicle from lifting-off, limiting operations of the aerial robotic vehicle within certain performance limits, and issuing a maintenance alert by the processor.

### BACKGROUND

Aerial robotic vehicles, also referred to as, “unmanned aerial vehicles,” “UAVs,” or “drones,” are commonly used for a variety of tasks. The performance of helicopter-type drones is heavily dependent upon the condition of the propellers. Thus, the structural integrity of the propellers is critical to the safe flight of an aerial robotic vehicle. A damaged propeller can result in reduced performance, attitude control, and positioning. A small crack or stress fracture can cause a significant mechanical failure during flight, causing the aerial robotic vehicle to become unstable and potentially crash. Often, damage is not readily apparent upon visual inspection, and without detection, a user could continue to fly the aerial robotic vehicle in an unsafe manner.

Pre-flight checks are often performed by flight crews to verify that conventional aircraft are safe to fly prior to taking off. For example, crews of commercial aircraft and crews responsible for an aerial robotic vehicle may perform pre-flight checks of various structures and systems to confirm the aircraft is functional and adequately safe for flight. However, flight crews or other personnel may not be able to inspect an aerial robotic vehicle while in-flight or when the aerial robotic vehicle is at a remote location.

### SUMMARY

Various embodiments provide methods, devices, systems, and non-transitory process-readable storage media for detecting anomalies in rotors of an aerial robotic vehicle and taking an action in response. Various embodiments include methods that may be implemented in a processor or processing device of an aerial robotic vehicle and that may include obtaining data from a sensor or sensors onboard the aerial robotic vehicle configured to detect anomalies in rotors, determining whether an anomaly is detected in any rotor based on the obtained data, and taking an action in response to detecting an anomaly in one or more rotors.

Some embodiments may include controlling a motor of the aerial robotic vehicle to maintain a low spin rate of the rotors that is below a lift-off spin rate, and obtaining data from the sensor(s) while the low spin rate is maintained. The lift-off spin rate may be a lowest rate of revolution for all rotors spinning sufficient to cause the aerial robotic vehicle to lift-off. The obtained data may correspond to a characteristic of the rotors while the rotors are not moving. In some embodiments, determining whether an anomaly is detected in any rotor may include comparing the obtained data to previously stored data, and determining that an anomaly is detected in response to a difference between the previously stored data and the obtained data exceeding a threshold.

In some embodiments, taking the action in response to detecting an anomaly in one or more rotors may include one or more of preventing the aerial robotic vehicle from lifting-off; limiting operations of the aerial robotic vehicle within certain performance limits; and issuing a maintenance alert. In some embodiments, taking the action in response to detecting an anomaly in one or more rotors may include preventing the aerial robotic vehicle from lifting-off until a corrective maintenance procedure is performed.

In some embodiments, taking the action in response to detecting an anomaly in one or more rotors may include one or more of transmitting a message reporting the obtained data to a remote computing device; determining whether the aerial robotic vehicle is airworthy enough to perform a flight plan; determining whether the aerial robotic vehicle is airworthy enough for current flight conditions; and re-configuring a flight parameter of the aerial robotic vehicle. In some embodiments, re-configuring the flight plan may include adding, removing, or modifying a waypoint in the flight plan. In some embodiments, the message to the remote computing device may request permission for the aerial robotic vehicle to fly.

In some embodiments, the sensor(s) onboard the aerial robotic vehicle may include one or more of a gyroscope, an accelerometer, a camera, and an altimeter. In some embodiments, the obtained data may relate to a physical condition of the rotors that may be observed visually. In some embodiments, the obtained data may relate to how the rotors operate while spinning. In some embodiments, the sensor(s) onboard the aerial robotic vehicle configured to detect anomalies in the rotors may be at least one of a conductive sensor, a resistive sensor, or a capacitive sensor on or embedded within one or more rotors that measure parameters related to flex in the rotors.

Further embodiments include an aerial robotic vehicle having a processor configured with processor-executable instructions for performing operations of the methods summarized above. Further embodiments include a processing device for use in an aerial robotic vehicle configured to perform operations of the methods summarized above. Further embodiments include a communication system including a processor configured with processor-executable instructions to send signals or messages to or from an aerial robotic vehicle to perform operations of the methods described above. Further embodiments include an aerial robotic vehicle having a sensor for detecting anomalies in one or more of rotors.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of an aerial robotic vehicle, including a communication system, suitable for use with the various embodiments.

FIGS. 2A-2E are diagrams illustrating anomalies detected on a rotor of an aerial robotic vehicle in accordance with various embodiments.

FIG. 3 is a process flow diagram illustrating methods for rotor anomaly detection and response for an aerial robotic vehicle having one or more rotors for propulsion according to some embodiments.

FIG. 4 is a process flow diagram illustrating methods for rotor anomaly response for an aerial robotic vehicle having one or more rotors for propulsion according to some embodiments.

FIG. 5 is a process flow diagram illustrating methods for responding to detected rotor anomalies by an aerial robotic vehicle having one or more rotors for propulsion according to some embodiments.

FIG. 6 is a component block diagram of a remote computing device suitable for use in some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and aerial robotic vehicles processing devices implementing such methods for automatically detecting anomalies in rotors and taking an action in response to detecting an anomaly. Actions that may be taken in response to detecting an anomaly may include preventing lift off, reconfiguring flight parameters (e.g., rotor speed, maximum permitted g forces, etc.), or modifying a flight plan in view of detected rotor anomalies.

The term “aerial robotic vehicle” is used herein to refer to various types of vehicles that are capable of autonomous flight and that include at least a processing unit for controlling flight of the vehicle according to stored instructions (e.g., data indicating a predetermined flight plan, etc.). Aerial robotic vehicles include unmanned aircraft that are capable of flying without any human interaction, with some human interaction (e.g., providing flight instructions to be executed by the processing unit), under partial human control, and under full human control (e.g., during take-off and landings.) Aerial robotic vehicles may be of various design types capable of executing vertical lift-offs, such as helicopter-type drones configured with any number of rotors (e.g., quad-copter aerial robotic vehicles having four rotors, etc.). Although aerial robotic vehicles may be selectively controlled by human operators, aerial robotic vehicles may be capable of independently performing at least a series of instructions, commands, and/or routines for testing flight stability as described herein. An aerial robotic vehicle includes a control system including a processor for executing processor-executable instructions for controlling the various functionalities of the aerial robotic vehicle, such as communications (e.g., wireless signaling via Wi-Fi®, Bluetooth®, Long Term Evolution (LTE), etc.), data collection (e.g., polling sensors, etc.), propulsion/navigation, power management, and stability management (e.g., calculating center-of-gravity, etc.). Aerial robotic vehicles may or may not be configured to carry payloads during missions, such as surveillance aerial robotic vehicles configured merely to travel to various locations in order to capture camera imagery or delivery aerial robotic vehicles configured to drop-off packages to a destination address and return to an address of origin.

The term “computing device” is used herein to refer to any one or all of cellular telephones, smart-phones, web-pads, tablet computers, Internet enabled cellular telephones, wireless local area network (WLAN) enabled electronic devices, laptop computers, dedicated healthcare electronic devices, personal computers, and similar electronic devices equipped with at least a processor and configured to communicate with a blood pressure measuring device described herein, such as a negligible interfering and negligible perception configuration or form blood pressure measuring device (e.g., a wearable patch, bracelet, anklet, watch, etc.).

In various embodiments, the aerial robotic vehicle may be configured to obtain and assess data from one or more sensors to determine various characteristics of the rotors of the aerial robotic vehicle, relevant to the ability of the aerial robotic vehicle to successfully fly (e.g., airworthiness). A sensor onboard the aerial robotic vehicle may be configured to detect anomalies in rotors of the aerial robotic vehicle. For example, the sensor onboard the aerial robotic vehicle may detect a rip, nick, bend, crease, fracture, and or other physical deficiencies in a rotor. In addition, unusual vibrations, movement, or other operation deviations from normal conditions may be detected that may jeopardize a safe and successful aerial robotic vehicle flight. A processor of the aerial robotic vehicle may determine whether an anomaly in the rotor is detected based on the obtained data. For example, one or more onboard cameras may provide imagery of the rotors, which a processor of the aerial robotic vehicle may analyze to determine whether an anomaly is detected on or with any of the rotors. In some embodiments, a conductive material or strain gauges may be embedded in or on the rotors (e.g., the entire length of the rotor) that the processor may test to determine whether an anomaly is present. For example, if a conductive material (e.g., a strip or fine wire) is embedded within rotors, the processor may apply a voltage to the conductive material to determine whether a circuit through the material is broken which would indicate a defect in the rotor. In some embodiments, resistive (e.g., strain gauge) or capacitive sensors may be embedded in rotors and used by a processor to determine whether flex in the rotors exceeds a nominal or acceptable threshold value.

The aerial robotic vehicle may be configured to perform various actions in response to determining that an anomaly has been detected. For example, a processor of the aerial robotic vehicle may further determine whether the aerial robotic vehicle is airworthy based on the detected anomaly. As another example, the processor may ground the aerial robotic vehicle if the aerial robotic vehicle is determined not to be airworthy. As another example, the processor may determine that the aerial robotic vehicle is airworthy with the detected anomaly, but limit operation of the aerial robotic vehicle to within certain operating performance limits. As another example, the processor may send a message or otherwise require maintenance on the aerial robotic vehicle in response to determining the aerial robotic vehicle is not airworthy base on the detected anomaly. As another example, processor may otherwise restrict and/or prevent flight by the aerial robotic vehicle in response to determining an anomaly has been detected.

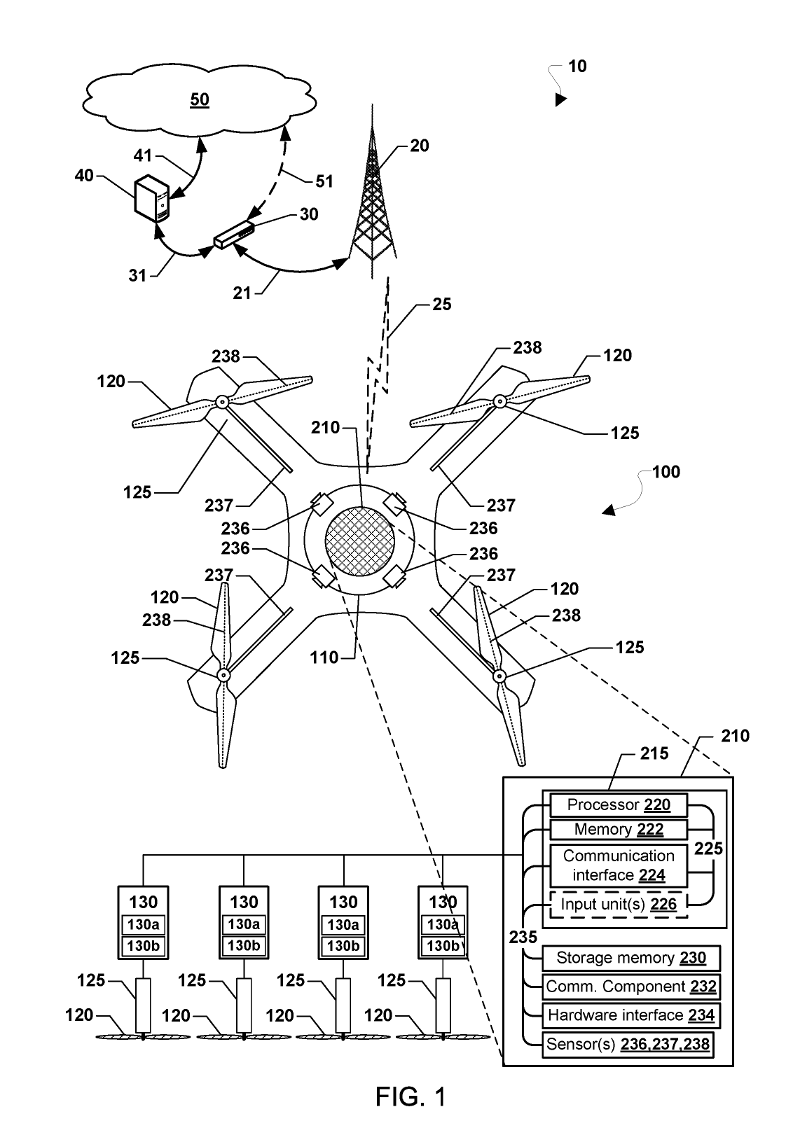

Various embodiments may be implemented within a variety of aerial robotic vehicles configured to communicate with one or more communication networks, an example of which suitable for use with various embodiments is illustrated in FIG. 1. With reference to FIG. 1, an aerial robotic vehicle 100 operating in a mission environment 10 may include a plurality of rotors 120 (e.g., four rotors), each driven by a corresponding motor 125. In addition, a body 110 of the aerial robotic vehicle 100 may support the plurality of rotors 120 and motors 125.

In various embodiments, the aerial robotic vehicle 100 may include one or more off various onboard sensors, such as one or more cameras 236, 237, one or more conductive strips 238 attached to the rotors 120, or a combination of one or more thereof. The processing device 210 may further include one or more additional sensor(s), such as an altimeter, that may be used by the processor 220 to determine flight attitude and location information to control various processes on the aerial robotic vehicle 100.

Cameras may be disposed in different types of locations on the aerial robotic vehicle 100 and one or more of different types of camera may be used. For example, a first set of cameras 236 may face a side of each of the rotors 120 in the plane of rotation thereof, such as mounted near a central part of the aerial robotic vehicle 100. A second set of cameras 237 may be mounted under the rotors 120. At low spin rates, such cameras 236, 237 may visually detect out-of-plane vibrations of the rotors 120. Also, when one of the rotors 120 is not spinning, other anomalies such as a rip, nick, bend, crease, or other damage may be detected through still-image analysis. Use of one or more cameras 236, 237 is a passive measurement that may not require active emissions or reflection of emissions. In addition, the one or more cameras 236, 237 may even detect a missing rotor (e.g., which may have fallen or was ripped off). At full flight speeds, aerial robotic vehicle rotors spin at an order of magnitude faster than helicopter blades, so the flex is less significant, but the failure is more common. Thus, unlike the types of observations made on contemporary helicopters, various embodiments may use video analysis to track more than just tip tracking; the flex of the entire blade may be observed.

In some embodiments, conductive strips 238 or strain gauges may be embedded in or on the rotors 120 (e.g., the entire length thereof) and connect to the vehicle in a manner that enables the processor to test circuits through the strips for continuity or resistance. For example, if the conductive material is broken, the break in the circuit through the rotor 120 may indicate a defect in the rotor. Such embodiments may use a slip-ring on the rotor 120 to maintain electrical connectivity from the processor through the conductive strips 238.

In some embodiments, active sensors located away from the rotors, but still on the aerial robotic vehicle, may enable the processor to measure passive materials embedded in or on the rotors.

The aerial robotic vehicle 100 may include a processing device 210 that is configured to monitor and control the various functionalities, sub-systems, and/or other components of the aerial robotic vehicle 100. For example, the processing device 210 may be configured to monitor and control various functionalities of the aerial robotic vehicle 100, such as any combination of modules, software, instructions, circuitry, hardware, etc. related to propulsion, navigation, power management, sensor management, and/or stability management.

The processing device 210 may house various circuits and devices used to control the operation of the aerial robotic vehicle 100. For example, the processing device 210 may include a processor 220 that directs the control of the aerial robotic vehicle 100. The processor 220 may include one or more processors configured to execute processor-executable instructions (e.g., applications, routines, scripts, instruction sets, etc.) to control flight, antenna usage, and other operations of the aerial robotic vehicle 100, including operations of various embodiments. In some embodiments, the processing device 210 may include memory 222 coupled to the processor 220 and configured to store data (e.g., flight plans, obtained sensor data, received messages, applications, etc.). The processor 220 and memory 222 may be configured as or include a system-on-chip (SoC) 215 along with (but not limited to) additional elements such as a communication interface 224, one or more input units 226, non-volatile storage memory 230, and a hardware interface 234 configured for interfacing the SoC 215 with hardware and components of the aerial robotic vehicle 100. Various components within the processing device 210 and/or the SoC 215 may be coupled together by various circuits, such as a bus 225, 235 or another similar circuitry.

The processing device 210 may be coupled to each of the plurality of rotors 120 by way of the corresponding motors 125. Optionally, each of the motors 125 may communicate with a sub-controller 130 that may handle functions including controlling aspects of the operation of the rotor's associated motor 125. Each sub-controller 130 may include a local processor 130a configured to execute processor-executable instructions that may be stored in a local memory 130b.

The processing device 210 may include more than one SoC 215 thereby increasing the number of processors 220 and processor cores. The processing device 210 may also include processors 220 that are not associated with the SoC 215. Individual processors 220 may be multi-core processors. The processors 220 may each be configured for specific purposes that may be the same as or different from other processors 220 of the processing device 210 or SoC 215. One or more of the processors 220 and processor cores of the same or different configurations may be grouped together. A group of processors 220 or processor cores may be referred to as a multi-processor cluster.

The terms “system-on-chip” or “SoC” as used herein, refer to a set of interconnected electronic circuits typically, but not exclusively, including one or more processors (e.g., 220), a memory (e.g., 222), and a communication interface (e.g., 224). The SoC 215 may include a variety of different types of processors 220 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SoC 215 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

The SoC 215 may include one or more processors 220. The processing device 210 may include more than one SoC 215, thereby increasing the number of processors 220 and processor cores. The processing device 210 may also include processors 220 that are not associated with the SoC 215 (i.e., external to the SoC 215). Individual processors 220 may be multi-core processors. The processors 220 may each be configured for specific purposes that may be the same as or different from other processors 220 of the processing device 210 or the SoC 215. One or more of the processors 220 and processor cores of the same or different configurations may be grouped together. A group of processors 220 or processor cores may be referred to as a multi-processor cluster.

In various embodiments, the processing device 210 may include or be coupled to one or more communication components 232, such as a wireless transceiver, an onboard antenna, and/or the like for transmitting and receiving wireless signals through the wireless communication link 25. The one or more communication components 232 may be coupled to the communication interface 224 and may be configured to handle wireless wide area network (WWAN) communication signals (e.g., cellular data networks) and/or wireless local area network (WLAN) communication signals (e.g., Wi-Fi signals, Bluetooth signals, etc.) associated with ground-based transmitters/receivers (e.g., base stations, beacons, Wi-Fi access points, Bluetooth beacons, small cells (picocells, femtocells, etc.), etc.). The one or more communication components 232 may receive data from radio nodes, such as navigation beacons (e.g., very high frequency (VHF) omni-directional range (VOR) beacons), Wi-Fi access points, cellular network base stations, radio stations, etc.

The processing device 210, using the processor 220, the one or more communication components 232, and an antenna may be configured to conduct wireless communications with a variety of remote computing devices, examples of which include the base station or cell tower (e.g., base station 20), a beacon, server, a smartphone, a tablet, or another computing device with which the aerial robotic vehicle 100 may communicate. The processor 220 may establish the wireless communication link 25 via a modem and the antenna. In some embodiments, the one or more communication components 232 may be configured to support multiple connections with different remote computing devices using different radio access technologies. In some embodiments, the one or more communication components 232 and the processor 220 may communicate over a secured communication link. The security communication links may use encryption or another secure means of communication in order to secure the communication between the one or more communication components 232 and the processor 220.

The aerial robotic vehicle 100 may operate in the mission environment 10 in conjunction with a base station 20, as well as a remote computing device 30, a remote server 40, and a communication network 50. The base station 20 may provide the wireless communication link 25, such as through wireless signals to the aerial robotic vehicle 100. The base station 20 may include one or more wired and/or wireless communications connections 21, 31, 41, 51 to the communication network 50. The communication network 50 may in turn provide access to other remote base stations over the same or another wired and/or wireless communications connection. The remote computing device 30 may be configured to control the base station 20, the aerial robotic vehicle 100, and/or control wireless communications over a wide area network, such as providing a wireless access points and/or other similar network access point using the base station 20. In addition, the remote computing device 30 and/or the communication network 50 may provide access to a remote server 40. The aerial robotic vehicle 100 may be configured to communicate with the remote computing device 30 and/or the remote server 40 for exchanging various types of communications and data, including location information, navigational commands, data inquiries, and mission data.

Aerial robotic vehicles may navigate or determine positioning using altimeters or navigation systems, such as Global Navigation Satellite System (GNSS), Global Positioning System (GPS), etc. In some embodiments, the aerial robotic vehicle 100 may use an alternate source of positioning signals (i.e., other than GNSS, GPS, etc.). The aerial robotic vehicle 100 may use position information associated with the source of the alternate signals together with additional information (e.g., dead reckoning in combination with last trusted GNSS/GPS location, dead reckoning in combination with a position of the aerial robotic vehicle takeoff zone, etc.) for positioning and navigation in some applications. Thus, the aerial robotic vehicle 100 may navigate using a combination of navigation techniques, including dead-reckoning, camera-based recognition of the land features below and around the aerial robotic vehicle 100 (e.g., recognizing a road, landmarks, highway signage, etc.), etc. that may be used instead of or in combination with GNSS/GPS location determination and triangulation or trilateration based on known locations of detected wireless access points.

In some embodiments, the processing device 210 of the aerial robotic vehicle 100 may use one or more of various input units 226 for receiving control instructions, data from human operators or automated/pre-programmed controls, and/or for collecting data indicating various conditions relevant to the aerial robotic vehicle 100. For example, the input units 226 may receive input from one or more of various components, such as camera(s), microphone(s), position information functionalities (e.g., a global positioning system (GPS) receiver for receiving GPS coordinates), flight instruments (e.g., attitude indicator(s), gyroscope(s), anemometer, accelerometer(s), altimeter(s), compass(es), etc.), keypad(s), etc. The camera(s) may be optimized for daytime and/or nighttime operation.

Aerial robotic vehicles may be winged or rotor craft varieties. For example, the aerial robotic vehicle 100 may be a rotary propulsion design that utilizes one or more rotors 120 driven by corresponding motors to provide lift-off (or take-off) as well as other aerial movements (e.g., forward progression, ascension, descending, lateral movements, tilting, rotating, etc.). The aerial robotic vehicle 100 is illustrated as an example of an aerial robotic vehicle that may utilize various embodiments, but is not intended to imply or require that various embodiments are limited to a quad-rotor aircraft.

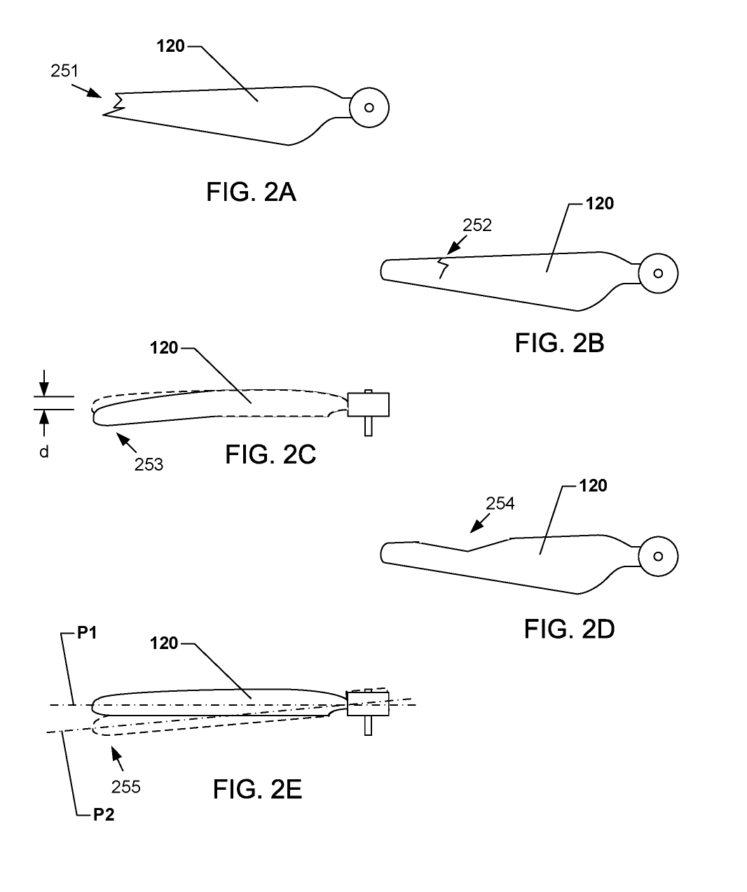

FIGS. 2A-2E illustrate exemplary anomalies on a rotor 120 that may be detected with systems and methods according to various embodiments. In FIGS. 2A-2E, only half of a rotor 120 is illustrated for ease of explanation. With reference to FIGS. 1-2E, the anomalies shown in FIGS. 2A-2E are merely illustrative and should not be considered to limit the possible anomalies that may be detected by an aerial robotic vehicle (e.g., 100).

The processor (e.g., 220) of an aerial robotic vehicle (e.g., 100) may perform monitoring operations (e.g., data collection and processing) before, during, and/or after flight, such as by accessing readings from on-board sensors to determine whether an anomaly in any of the rotors is detected. In particular, the processor may receive and analyze images (i.e., video or still images) from one or more cameras (e.g., cameras 236, 237). The images received by the processor may show all or half of the rotor 120 since the rotors may be rotated during inspection. Camera angles that provide images of the entire rotor 120 may be preferred for analyzing the rotors when the rotors are not spinning. Alternatively, the processor may control the rotor motors to slowly or incrementally rotate the rotors so that images can be obtained of the full extent of each blade when a camera's perspective does not permit imaging the entire rotor in a single image.

FIG. 2A illustrates a nick 251 in a tip of the rotor 120 viewed from under the rotor (i.e., a plan view). The processor of the aerial robotic vehicle analyzing an image of the rotor 120 may recognize that an overall length of the rotor 120 is not as long as it is supposed to be or that a current profile shape of the rotor 120 does not match a normal profile shape. The processor may also assess, based on the degree of the normal profile shape that is missing, whether the aerial robotic vehicle is airworthy. For example, if less than 5% of the overall surface area of the rotor 120 is missing, the processor may determine the aerial robotic vehicle may still fly, but issue a maintenance alert regarding the detected anomaly. In addition, the determination regarding airworthiness may depend on current circumstances, such as the availability of a replacement rotor or how urgently the aerial robotic vehicle needs to fly.

FIG. 2B illustrates a rip 252 in a portion of the rotor 120 viewed from under the rotor. The processor of the aerial robotic vehicle may recognize that the normally solid central portions of the rotor 120 have a separation, crack, or imperfection line that may be associated with an anomaly such as the rip 252. The processor may also assess, based on the extent of the rip 252, whether the aerial robotic vehicle is airworthy. For example, if the rip 252 extends across less than 25% of a longitudinal or lateral extend of the rotor 120, the processor may determine the aerial robotic vehicle may still fly. Alternatively, a detected rip of any length may be sufficient for the processor to determine the aerial robotic vehicle is not airworthy. In addition, the determination regarding airworthiness may depend on current circumstances.

FIG. 2C illustrates a bend 253 in a tip of the rotor 120 viewed from a plane of rotation of the rotor 120. The processor of the aerial robotic vehicle may recognize that a current profile shape of the rotor 120 does not match a normal profile shape. The processor may also assess, based on the degree of deflection d in the rotor 120, whether the aerial robotic vehicle is airworthy. Alternatively, a detected bend of any degree may be sufficient for the processor to determine the aerial robotic vehicle is not airworthy. In addition, the determination regarding airworthiness may depend on current circumstances.

FIG. 2D illustrates a crease 254 in the rotor 120 viewed from under the rotor. The processor of the aerial robotic vehicle may recognize that an outer perimeter of the rotor 120 is not intact (i.e., a current profile shape of the rotor 120 does not match a normal profile shape). The processor may also assess, based on the degree of the normal profile shape that is missing or deformed, whether the aerial robotic vehicle is airworthy. For example, if less than 5% of the overall surface area of the rotor 120 is missing, the processor may determine the aerial robotic vehicle may still fly, but issue a maintenance alert regarding the detected anomaly. In addition, the determination regarding airworthiness may depend on current circumstances.

FIG. 2E illustrates the rotor 120 viewed from a plane of rotation of the rotor 120. The processor of the aerial robotic vehicle may recognize that the rotor 120 is spinning out of plane (i.e., a current plane of rotation P2 does not match a normal plane of rotation P1). The processor may also assess, based on the degree of rotational pitch 255 (i.e., how far from the normal plane of rotation P1) whether the aerial robotic vehicle is airworthy. Alternatively, any degree of rotational pitch may be sufficient for the processor to determine the aerial robotic vehicle is not airworthy. In addition, the determination regarding airworthiness may depend on current circumstances.

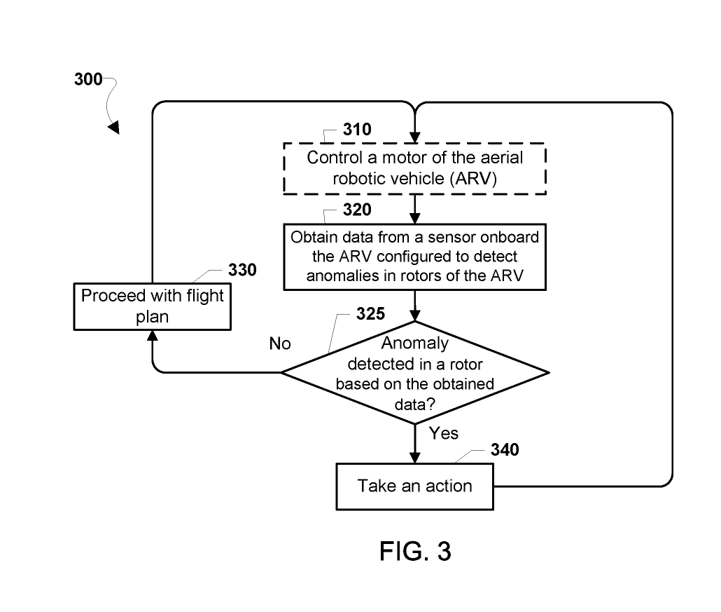

FIG. 3 illustrates a method 300 for rotor anomaly detection and response for an aerial robotic vehicle having one or more rotors for propulsion according to some embodiments. With reference to FIGS. 1-3, the method 300 may be performed by a processor, such as a processor (220) within a processing device (e.g., 210) of an aerial robotic vehicle (e.g., 100) to detect anomalies in rotors (e.g., 120) and perform an action in response.

In optional block 310, the processor may optionally control motors of the aerial robotic vehicle to ensure the one or more rotors are either not spinning or spinning at a pre-established rate of revolution for anomaly detection. For example, the processor may send signals to cause one or more of the motors (e.g., 125) of the aerial robotic vehicle (e.g., 101) to apply sufficient power to the rotor(s) (e.g., 120) to cause the aircraft to maintain a low spin rate that is below a lift-off spin rate. As used herein, the “lift-off spin rate” refers to a lowest rate of revolution, for all rotors spinning, sufficient to cause the aerial robotic vehicle to lift-off the ground or other surface upon which it is supported. The processor may control motors of the aerial robotic vehicle to enable a camera to inspect the entire length of each blade on each rotor, such as by slowly or incrementally rotating each rotor at a rate that enables a camera to obtain images sufficient for analysis by the processor. The processor may control motors of the aerial robotic vehicle to prevent the rotors from spinning, such as to measure a static condition of one or more rotors. As a further example, after lift-off (i.e., when the aerial robotic vehicle is in-flight), the processor may control motors of the aerial robotic vehicle to maintain a fixed rate of revolution that maintains flight for taking measurements mid-flight. Controlling the motors in this manner may be optional if the motors are already operating at a rotational speed suitable for inspection by the camera or other sensor(s), in which case no changes to the motors may be needed.

In block 320, the processor may obtain data from a sensor onboard the aerial robotic vehicle for detecting anomalies in a rotor of the one or more rotors. For example, the processor may receive and process images from one or more cameras (e.g., 236, 237), resistance or current from conductive materials (e.g., the conductive strips 238), accelerometer data while rotors are spinning at a rate less than take off speeds, and/or data from other types of sensors. The data from the onboard sensor(s) may be obtained under various conditions. For example, the rotor(s) being measured may be spinning a low-speed, which may reveal low frequency variations or vibrations (as may be measured by accelerometers within the avionics systems). As another example, the rotors may be stopped to enable static observations using cameras and/or sensors embedded within rotor blades. The obtained data may be stored for tracking usage history or incident data (e.g., an unusual circumstance detected that may compromise a rotor) per rotor. Usage history and incident data may also be used to recognize a maintenance/replacement schedule (e.g., hours flown or damage/crash history).

Cameras may be used exclusively or in combination with other sensors. One or more cameras may be mounted under the rotors or in the plane of the rotors. At low spin rates, out-of-plane vibrations may be detected in camera-obtained images, and such observations may be combined with accelerometer data (e.g., from the avionics system). When a rotor is not spinning, structural anomalies (e.g., rip, nick, bend, crease, or similar damage) may be detected through analysis of still images. A camera may take images without requiring active emissions or reflection of emissions on the rotor. A camera may detect a missing rotor (e.g., fallen off or was ripped off). Also, video analysis tracks more than just tip tracking; the flex of the entire rotor blade may be observed, which is not done for helicopters or other rotor craft.

Conductive material may be embedded in or on the rotors (e.g., the conductive strips 238 in FIG. 1), which if broken may indicate a defect in the rotor. Similarly, the rotors may include strain gauges mounted on or within rotor blades and configured to detect defects in a rotor. Also, resistive or capacitive sensors may be attached to or embedded in a rotor. Elements, such as conductive materials, strain gauges, resistive, and/or capacitive sensors in/on the rotors may require a slip ring on the rotor in order to maintain electrical connectivity for the sensor to provide data to the processor. Alternatively, active sensors mounted on a body of the aerial robotic vehicle, but remote from the rotors, may measure passive material embedded in or on the rotor.

The processor may also poll or measure power used by various functionalities of the aerial robotic vehicle during or in response to controlling the motors to spin one or more rotors at a fixed spin rate. For example, the processor may determine a spin rate or an amount of lift provided when a specific amount of power is applied to each of the motors and compare the determined values to expected values to determine whether the rotors are operating properly. As another example, the processor may measure the power drawn by a motor when spinning a rotor at a given rate.

In determination block 325, the processor may determine whether an anomaly in a rotor is detected based on the data obtained in block 320. Various types of anomalies may be detected. For example, physical anomalies may be detected, such as a rip, nick, bend, crease, fracture (including micro-fracture(s)), improper installation, failure to deploy (on retractable/foldable rotor/frame vehicles), or a missing/lost rotor. As an additional example, functional anomalies may be detected, such as unusual vibrations, movement (including flex profile), and/or improper operating speeds for a fixed input current.

In determining whether an anomaly in a rotor is detected, the processor may analyze rotor images obtained by a camera to assess of a flex profile at a low spin rate and compare observations across multiple rotors. If the processor observes that one rotor flexes more or less than others, there may be a twist or a different torsion force, which may reflect damage or a defect. As a further example, direct current offsets may be measured to detect abnormalities. Additionally, the processor may compare how much one rotor flexes at a particular RPM to historical or threshold values of normal operations. The processor may also determine a risk of future breakage, damage, and/or failure, be based on usage history or incident data.

The processor may assess measurements of the power applied to each rotor by the flight control system while maintaining a low spin rate and compare the applied power or differences across the rotors to predefined default values (e.g., typical power applied to the rotors with/without a payload) or stability thresholds to determine whether a center of gravity of the aerial robotic vehicle is properly positioned and stable enough for safe flight.

In response to determining that no anomaly in a rotor is detected (i.e., determination block 325=“No”), the processor may proceed with a current flight plan in block 330.

In response to determining that an anomaly in a rotor is detected (i.e., determination block 325=“Yes”), the processor may take an action based on the detected anomaly in block 340. The action taken in block 340 may be based on current conditions, as well as the level and/or type of anomaly detected. One or more of various actions may be taken. For example, in response to determining that an anomaly was detected, the processor may determine whether the aerial robotic vehicle is airworthy when considering the detected anomaly. Thus, even though an anomaly is detected, the processor may determine that the aerial robotic vehicle is airworthy. In addition, once the aerial robotic vehicle is determined to be airworthy, the processor may take further actions, such as limiting operations of the aerial robotic vehicle. For example, the processor may limit operation of the aerial robotic vehicle within certain performance limits (e.g., below a predetermined revolutions per minute (RPM) limit, limit speed, acceleration, limit types of maneuvers, altitude, range, etc.), which may limit the controls of the aerial robotic vehicle rather than a flight plan. Alternatively, in response to determining that the aerial robotic vehicle is not airworthy, the processor may ground the aerial robotic vehicle in block 340.

As another example of an action that may be taken in block 340 based on a detected anomaly, the processor may force maintenance on the aerial robotic vehicle. For example, in response to an event, such as a crash or heavy impact to the aerial robotic vehicle or a particular rotor, the processor may force maintenance on the aerial robotic vehicle. Alternatively or additionally, the processor may issue a maintenance alert once an anomaly is detected.

Another example of an action that may be taken in block 340 includes the processor downloading a set of instructions, such as an updated flight plan, for operating the aerial robotic vehicle in view of a detected anomaly. The flight plan may be better suited to the aerial robotic vehicle in view of the detected anomaly, such as a closer destination where repairs may be obtained. The flight plan may include coordinates, turn lists, changes in altitude, hovers, etc., as well as flight parameters associated with various portions of the flight plan, such as airspeed, altitude, power usage, allowed maneuvers, or rotor configurations to use during particular segments of the flight plan. In some embodiments, the flight plan data may be a list of commands or a script to perform for moving the aerial robotic vehicle. Data indicating flight conditions associated with the flight plan may include real-time data and/or historic data indicating the weather, traffic, geography (e.g., terrain type, sea level, etc.), wind characteristics, and other information relevant to operating aircraft along the flight plan. For example, the flight conditions may indicate that there is currently or predicted to be a storm along the preset flight route from a warehouse to a customer's house, which may be avoided with an updated flight plan.

In some embodiments, the processor may repeat the operations of the method 300 to detect and respond to rotor anomalies in all rotors of an aerial robotic vehicle having one or more rotors. For example, the processor may repeat the operations of the method 300 continuously or until all rotors are checked to ensure safe and proper operation of the aerial robotic vehicle. As another example, the processor may repeat the operations of the method 300 for a predefined number of iterations indicated in pre-flight testing instructions provided to the aerial robotic vehicle before take-off. Thereafter, the processor may optionally repeat the operations of the method 300 at regular intervals during flight or at other times established for doing so.

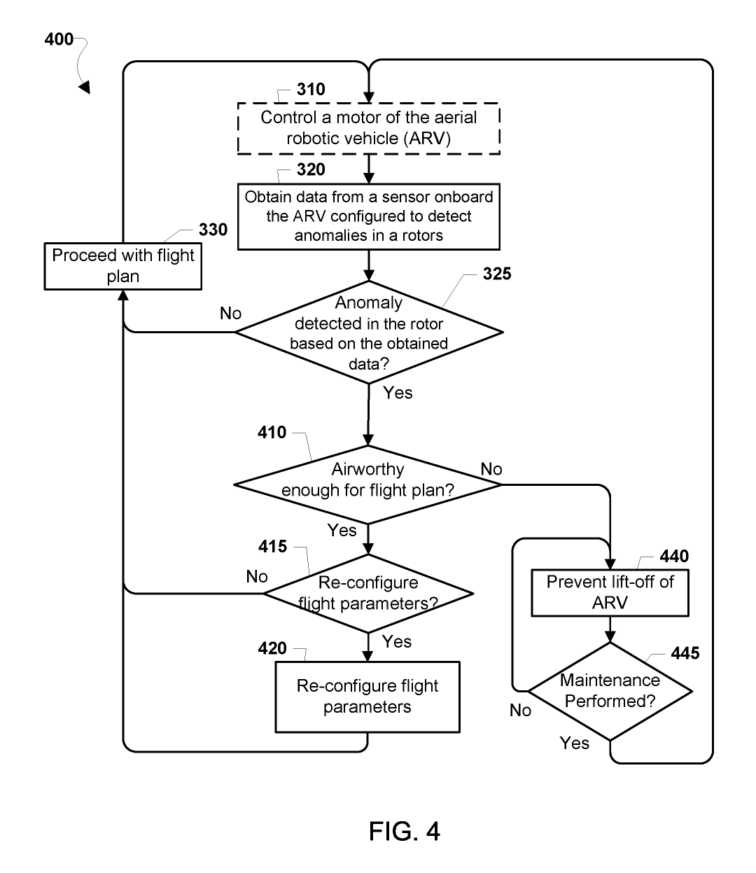

FIG. 4A illustrates a method 400 for responding (i.e., actions that may be taken) to rotor anomaly detection according to some embodiments. With reference to FIGS. 1-4A, the method 400 may be performed by a processor, such as a processor (220) within a processing device (e.g., 210) of an aerial robotic vehicle (e.g., 100) to detect anomalies in rotors (e.g., 120) and perform an action in response. In the method 400, the processor may perform operations of blocks 310, 320, 235 and 330 of the method 300 as described.

In response to detecting an anomaly in a rotor (i.e., determination block 325=“Yes”), the processor may the processor may determine whether the aerial robotic vehicle is airworthy enough for a current flight plan in determination block 410. Such a determination may be based on the type and extent of the anomaly in the rotor determined in determination block 325.

A determination regarding airworthiness may take into account a current flight plan, as well as conditions in which the aerial robotic vehicle will travel. The conditions being considered may include a current state of the aerial robotic vehicle, such as current power levels, loads, the type or extent of the detected anomaly, and/or additional conditions influence flight of the aerial robotic vehicle. Additionally, the conditions being considered may include external factors, such as whether, length of the flight plan, anticipated maneuvers, aerial congestion, and/or additional external factors that may influence flight of the aerial robotic vehicle.

In some embodiments, the aerial robotic vehicle may be configured to evaluate various conditions, characteristics, functionalities, and other metrics, such as any factors that may affect airworthiness (e.g., engine time before overhaul (TBO), rotor speeds, etc.). For example, the aerial robotic vehicle may evaluate the power draw on batteries, the fuel usage, and/or the processing toll that may be incurred during operation of the rotors. A processor of the aerial robotic vehicle may use such information to evaluate the likelihood of successfully completing a flight plan (or travel route). As another example, the aerial robotic vehicle may evaluate current engine TBO with regard to an estimated time for an upcoming flight plan and/or power usage and/or speed to identify whether the aircraft may become un-airworthy with regard to pre-established standards (e.g., Federal Aviation Regulations (FAR)).

In response to determining that the aerial robotic vehicle is airworthy for a current flight plan (i.e., determination block 410=“Yes”), the processor may determine whether flight parameters of the aerial robotic vehicle need to be re-configured in determination block 415. In some embodiments, in order to determine whether to reconfigure flight parameters in determination block 415, the processor may obtain instructions by retrieving data from local or remote storage or memory and/or receiving (or downloading) instructions from other devices, such as a server (e.g., 40) or other remote computing device. For example, the processor of the aerial robotic vehicle may download instructions from a server, desktop, mobile device, or other device that is used by a human operator to control or provide inputs to the aerial robotic vehicle. In some embodiments, the instructions may be related to the particular type, class, and/or structure of the aerial robotic vehicle or the detected anomaly. In some embodiments, the instructions may be based on standard flight protocols and/or regulations, such as Federal Aviation Administration (FAA) requirements or specifications for particular types of aircraft. For example, based on general safety requirements for aerial robotic vehicles, the instructions may include instructions requiring the aerial robotic vehicle to fly in a particular way.

In response to determining that the aerial robotic vehicle is not airworthy enough for the current flight plan (i.e., determination block 410=“No”), the processor may prevent lift-off of the aerial robotic vehicle in block 440. In determination block 445, the processor may monitor sensors or user inputs to determine whether maintenance has been performed sufficient to repair the detected anomaly. So long as such maintenance is not performed (i.e., determination block 445=“No”), the processor may continue to prevent lift-off of the aerial robotic vehicle in block 440. In response to determining that such maintenance has been performed (i.e., determination block 445=“Yes”), the processor may again control a motor of the aerial robotic vehicle and repeat the operations of the method 400 as described.

In response to determining that the aerial robotic vehicle should reconfigure flight parameters (i.e., determination block 415=“Yes”), the processor may re-configure flight parameters in block 420 (e.g., re-route or change a flight plan, change speed during a flight plan, etc.). In some embodiments, re-configuring flight parameters may include the processor adjusting power use parameters for individual motors within the aerial robotic vehicle based on the obtained data. For example, in response to determining that one of the rotors is damaged and spinning more slowly than the others, the processor may adjust power use settings for a particular motor to cause a greater amount of power to be consumed in order to improve balance of the aircraft.

In some embodiments, the processor may reconfigure flight parameters in block 420, such as by adjusting power usage allowable during a flight plan, setting upper bounds for an acceptable amount of battery discharge or fuel consumption for a period of time during the flight plan, and the like. For example, the processor may set a variable to determine the battery efficiency (or fuel consumption) that is acceptable or allowable during a flight plan so that the aerial robotic vehicle may perform assigned duties without reaching a hazardously low level of power available. In some embodiments, the processor may adjust or reconfigure other flight parameters based on such power usage configurations. For example, based on a newly configured maximum allowable power draw, the processor may adjust the top speed allowed during the flight plan, the number of turns (and thus invalidating certain alternative routes), the maximum g force that the avionics system can command the aerial robotic vehicle to take, the maximum climb rated, and other parameters for controlling the aerial robotic vehicle while executing the flight plan.

In some embodiments, the processor may re-configure flight parameters in block 420 by re-routing the flight plan based on the stability determinations and/or other factors. For example, the processor may add or remove waypoints in the flight plan to accommodate weather conditions and/or the adjusted flight parameters of the aerial robotic vehicle. In some embodiments, the processor may also utilize other information about the aerial robotic vehicle, such as average battery draw-down, age on motors, etc., in order to adjust the flight parameters and/or flight plan. In some embodiments, the processor may adjust the flight plan such that a plotted path or route has an improved likelihood of success based on the determinations of the current capabilities of the aerial robotic vehicle. For example, the processor associated with the aerial robotic vehicle and/or a remote server configured to program the flight plan for the aerial robotic vehicle may adjust altitude and/or add, remove, and/or modify waypoints of the flight plan in order to move the aerial robotic vehicle through areas with fair weather that may not require actions that would endanger the safety of the aerial robotic vehicle. Adjustments to the flight plan may include changing one or more values of coordinates of waypoints of the flight plan. For example, in order to cause the aerial robotic vehicle to fly over an identified patch of bad weather, the processor may adjust the altitude of a three-dimensional (3D) waypoint.

In response to determining that the flight parameters of the aerial robotic vehicle should not be reconfigured (i.e., determination block 415=“No”) or after re-configuring the flight parameters in block 420, the processor may proceed with a current or updated flight plan in block 330 of the method 300 as described.

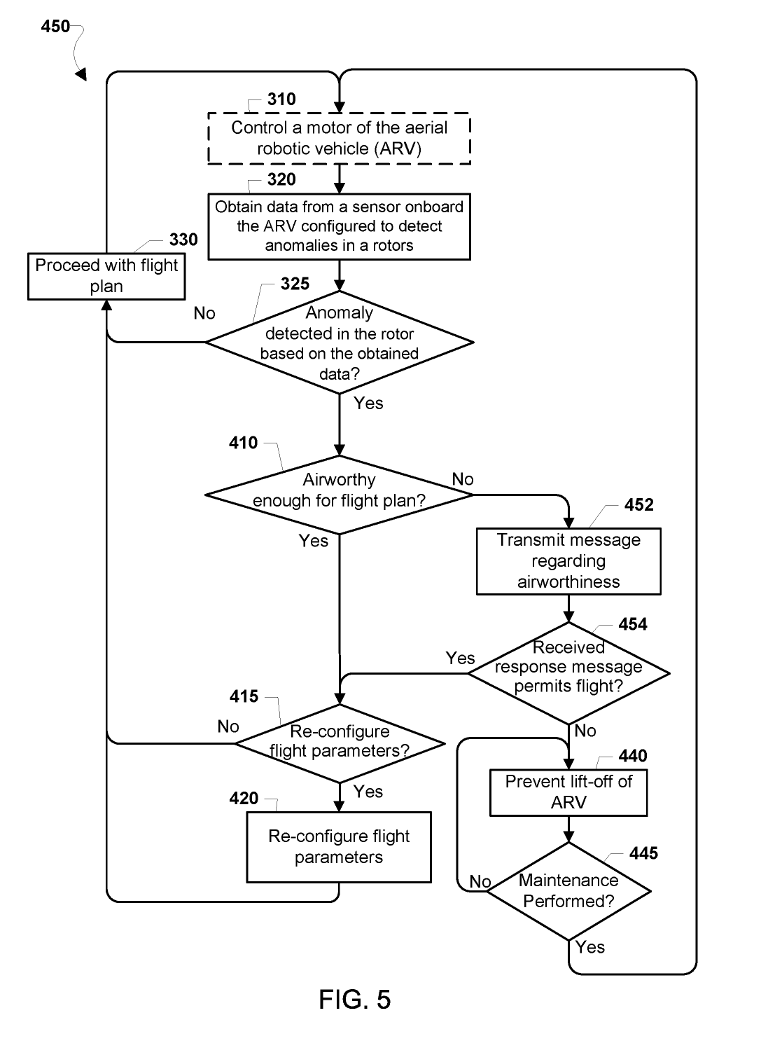

FIG. 5 illustrates another method 450 for responding to rotor anomaly detection according to some embodiments. With reference to FIGS. 1-5, the method 450 may be performed by a processor, such as a processor (220) within a processing device (e.g., 210) of an aerial robotic vehicle (e.g., 100) to detect anomalies in rotors (e.g., 120) and perform an action in response. In the method 450, the processor may perform operations of blocks 310, 320, 235 and 330 of the method 300 and blocks 410-445 of the method 400 as described.

In response to determining that the aerial robotic vehicle is not airworthy enough for the current flight plan (i.e., determination block 410=“No”), the processor may transmit a message regarding airworthiness to a remote computing device in block 452. For example, the processor may transmit an anomaly report to a remote server (e.g., 40) or mobile computing device (e.g., a smartphone or vehicle controller). In some embodiments, the transmitted message may include data regarding the detect anomaly and a request for clearance to fly with the detected anomaly. Alternatively, the transmitted message may be configured to improve or attempt to improve operating situations (e.g., transmit a message requesting a battery charge, more fuel, re-assignment to an easier delivery route, a request for a new flight plan, etc.).

In determination block 415, the processor may determine whether flight parameters for the aerial robotic vehicle need to be reconfigured. In some embodiments, in order to make the determination in determination block 415, the processor may obtain instructions by retrieving data from local or remote storage or memory and/or receiving (or downloading) instructions from other devices, such as a server or other remote computing device. For example, the processor of the aerial robotic vehicle may download instructions from a server, desktop, mobile device, or other device that is used by a human operator to control or provide inputs to the aerial robotic vehicle. In some embodiments, the instructions may be related to the particular type, class, and/or structure of the aerial robotic vehicle or the detected anomaly. In some embodiments, the instructions may be based on standard flight protocols and/or regulations, such as Federal Aviation Administration (FAA) requirements or specifications for particular types of aircraft. For example, based on general safety requirements for aerial robotic vehicles, the instructions may include instructions requiring the aerial robotic vehicle to fly in a particular way.

In response to determining that the aerial robotic vehicle should reconfigure flight parameters (i.e., determination block 415=“Yes”), the processor may re-configure flight parameters in block 420 (e.g., re-route or change a flight plan, change speed during a flight plan, etc.).

In some embodiments, re-configuring flight parameters may include the processor adjusting power use parameters for individual motors within the aerial robotic vehicle based on the obtained data. For example, in response to determining that one of the rotors is damaged and spinning more slowly than the others, the processor may adjust power use settings for a particular motor to cause a greater amount of power to be consumed in order to improve balance of the aircraft.

In some embodiments, the processor may re-configure flight parameters by adjusting power usage allowable during a flight plan, such as by setting upper bounds for an acceptable amount of battery discharge or fuel consumption for a period of time during the flight plan. For example, the processor may set a variable to determine the battery efficiency (or fuel consumption) that is acceptable or allowable during a flight plan so that the aerial robotic vehicle may perform assigned duties without reaching a hazardously low level of power available. Other flight parameters may be re-configured based on such power usage configurations. For example, based on a newly configured maximum allowable power draw, the processor may adjust the top speed allowed during the flight plan, the number of turns (and thus invalidating certain alternative routes), and other particulars of the flight plan data.

In some embodiments, the processor may re-configure flight parameters by re-routing the flight plan based on the stability determinations and/or other factors. For example, the processor may add or remove waypoints in the flight plan to accommodate weather conditions and/or the adjusted flight parameters of the aerial robotic vehicle. In some embodiments, the processor may also utilize other information about the aerial robotic vehicle, such as average battery draw-down, age on motors, etc., in order to adjust the flight parameters and/or flight plan. In some embodiments, the processor may adjust the flight plan such that a plotted path or route has an improved likelihood of success based on the determinations of the current capabilities of the aerial robotic vehicle. For example, the processor associated with the aerial robotic vehicle and/or a remote server configured to program the flight plan for the aerial robotic vehicle may adjust altitude and/or add, remove, and/or modify waypoints of the flight plan in order to move the aerial robotic vehicle through areas with fair weather that may not require actions that would endanger the safety of the aerial robotic vehicle. Adjustments to the flight plan may include changing one or more values of coordinates of waypoints of the flight plan. For example, in order to cause the aerial robotic vehicle to fly over an identified patch of bad weather, the processor may adjust the altitude of a three-dimensional (3D) waypoint.

In response to determining that the flight parameters of the aerial robotic vehicle should not be reconfigured (i.e., determination block 415=“No”) or after re-configuring the flight parameters in block 420, the processor may proceed with a current flight plan (i.e., an updated flight plan) in block 330, as described for the method 300.

In optional block 452, the processor may transmit a message requesting clearance to fly to a remote computing device, such as a ground-based operator station or a server monitoring operations of the aerial robotic vehicle. For example, the processor may wirelessly transmit sensor data received from on-board sensors (e.g., camera(s), etc.) of the aerial robotic vehicle to a server for evaluation by a human operator or processing via the server. For example, the message may indicate that obtained sensor data is outside of an acceptable threshold for a detected anomaly based on known characteristics of the aerial robotic vehicle, and thus there may be something wrong with a rotor. In some embodiments, the message may indicate a recommendation to human operators for adjusting or replacing a rotor, including the detected anomaly.

In response to transmitting the message regarding airworthiness, in optional block 452, the processor may determine whether a received response message permits or authorizes the aerial robotic vehicle for flight in determination block 454. In some situations, a response message may include a clearance to fly indication in view detected anomaly. In some situations, a response message may include instructions for reconfiguring the flight path and/or flight parameters that the processor may consider in determination block 415 as described. In some situations, a response message may include instructions to redirect the aerial robotic vehicle to a location for repairs or other maintenance. In some situations, a response message may deny permission for flight, cancel the flight plan, instruct a full shutdown, or otherwise instruct the aerial robotic vehicle to remain on the ground.

In response to determining that a received response message permitting flight was received (i.e., determination block 454=“Yes”), the processor may determine whether the aerial robotic vehicle needs to re-configure flight parameters in determination block 415 as described. In response to determining that no response message was received (i.e., determination block 454=“No”), the processor may prevent lift-off of the aerial robotic vehicle in block 440 as described.

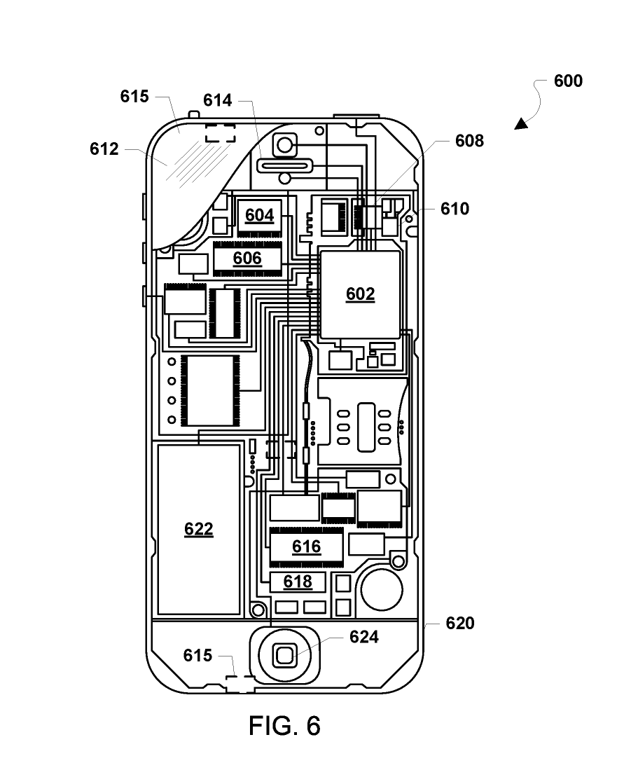

As described, the processor (e.g., 220) of the aerial robotic vehicle (e.g., 100) may determine whether an anomaly in a rotor is detected, may determine whether vehicle flight is authorized despite the anomaly based on commands received or data obtained from a remote computing device. In such embodiments, communications with the aerial robotic vehicle may be implemented including personal computers, wireless communication devices (e.g., smartphones, etc.), servers, laptop computers, etc., an example of which in the form of a smartphone 600 is illustrated in FIG. 6. With reference to FIGS. 1-6, a remote computing device 600 may include a processor 602 coupled with the various systems and components. For example, the processor 602 may be coupled to a touch screen controller 604, radio communication elements, speakers and microphones, and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof.

The touch screen controller 604 and the processor 602 may also be coupled to a touch screen panel 612, such as a resistive-sensing touch screen, capacitive-sensing touch screen, infrared sensing touch screen, etc. Additionally, the display of the remote computing device 600 need not have touch screen capability. The remote computing device 600 may have one or more radio signal transceivers 608 (e.g., Peanut, Bluetooth, Bluetooth LE, ZigBee, Wi-Fi®, radio frequency (RF) radio, etc.) and antennae, the remote computing device antenna 610, for sending and receiving communications, coupled to each other and/or to the processor 602. The radio signal transceivers 608 and the remote computing device antenna 610 may be used with the above-mentioned circuitry to implement the various wireless transmission protocol stacks and interfaces. The remote computing device 600 may include a cellular network wireless modem chip 616 coupled to the processor that enables communication via a cellular network.

The remote computing device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

In various embodiments, the remote computing device 600 may include one or more microphones 615. For example, the remote computing device may have microphones 615 that are conventional for receiving voice or other audio frequency energy from a user during a call. The remote computing device 600 may also include speakers 614 for providing audio outputs. The remote computing device 600 may also include a housing 620, constructed of a plastic, metal, or a combination of materials, for containing all or some of the components. The remote computing device 600 may include a power source 622 coupled to the processor 602, such as a disposable or rechargeable battery. The rechargeable battery may also be coupled to the peripheral device connection port to receive a charging current from a source external to the remote computing device 600. The remote computing device 600 may also include a physical button 624 for receiving user inputs.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any example embodiment. For example, one or more of the operations of the methods 300 and/or 400 may be substituted for or combined with another.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with various embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method for operating an aerial robotic vehicle, comprising:
obtaining, by a processor of the aerial robotic vehicle, data from a sensor onboard the aerial robotic vehicle configured to detect anomalies in rotors;
determining, by the processor, whether an anomaly is detected in any rotor based on the obtained data; and
taking an action, by the processor, in response to detecting an anomaly in one or more rotors.

2. The method of claim 1, further comprising:
controlling, by the processor, a motor of the aerial robotic vehicle to maintain a low spin rate of the rotors that is below a lift-off spin rate, wherein obtaining data from the sensor is performed by the processor while the low spin rate is maintained.

3. The method of claim 2, wherein the lift-off spin rate is a lowest rate of revolution for all rotors spinning sufficient to cause the aerial robotic vehicle to lift-off.

4. The method of claim 1, wherein the obtained data corresponds to a characteristic of the rotors while the rotors are not moving.

5. The method of claim 1, wherein determining whether an anomaly is detected in any rotor comprises comparing the obtained data to previously stored data and determining that an anomaly is detected in response to a difference between the previously stored data and the obtained data exceeding a threshold.

6. The method of claim 1, wherein taking the action in response to detecting an anomaly in one or more rotors comprises:
preventing the aerial robotic vehicle from lifting-off.

7. The method of claim 1, wherein taking the action in response to detecting an anomaly in one or more rotors comprises:
limiting operations of the aerial robotic vehicle within certain performance limits.

8. The method of claim 1, wherein taking the action in response to detecting an anomaly in one or more rotors comprises:
issuing a maintenance alert by the processor.

9. The method of claim 8, further comprising:
preventing the aerial robotic vehicle from lifting-off until a corrective maintenance procedure is performed.

10. The method of claim 1, wherein taking the action in response to detecting an anomaly in one or more rotors comprises:
transmitting, by the processor, a message reporting the obtained data to a remote computing device.

11. The method of claim 10, wherein the message to the remote computing device requests permission for the aerial robotic vehicle to fly.

12. The method of claim 1, wherein taking the action in response to detecting an anomaly in one or more rotors comprises:
determining, by the processor, whether the aerial robotic vehicle is airworthy enough to perform a flight plan.

13. The method of claim 1, wherein taking the action in response to detecting an anomaly in one or more rotors comprises:
determining, by the processor, whether the aerial robotic vehicle is airworthy enough for current flight conditions.

14. The method of claim 1, wherein taking the action in response to detecting an anomaly in one or more rotors comprises:
re-configuring, by the processor, a flight parameter of the aerial robotic vehicle.

15. The method of claim 14, wherein re-configuring the flight plan comprises adding, removing, or modifying a waypoint in the flight plan.

16. The method of claim 1, wherein the sensor onboard the aerial robotic vehicle includes one or more of a gyroscope, an accelerometer, a camera, and an altimeter.

17. The method of claim 1, wherein the obtained data relates to a physical condition of the rotors that may be observed visually.

18. The method of claim 1, wherein the obtained data relates to how the rotors operate while spinning.

19. The method of claim 1, wherein the sensor onboard the aerial robotic vehicle configured to detect anomalies in the rotors is at least one of a conductive, resistive or capacitive sensor on or embedded within one or more rotors that measure flex in the rotors.

20. An aerial robotic vehicle, comprising:
a sensor onboard the aerial robotic vehicle configured to detect anomalies in rotors; and
a processor coupled to the sensor and configured with processor-executable instructions to:
obtain data from the sensor;
determine whether an anomaly is detected in any rotor based on the obtained data; and
take an action in response to detecting an anomaly in one or more of the rotors.

21. The aerial robotic vehicle of claim 20, wherein the processor is further configured with processor-executable instructions to:
control a motor of the aerial robotic vehicle to maintain a low spin rate of the rotors that is below a lift-off spin rate; and
obtain the data from the sensor while the low spin rate is maintained.

22. The aerial robotic vehicle of claim 20, wherein the processor is further configured with processor-executable instructions determine whether an anomaly is detected in any rotor by:
comparing the obtained data to previously stored data; and
determining that an anomaly is detected in response to a difference between the previously stored data and the obtained data exceeding a threshold.

23. The aerial robotic vehicle of claim 20, wherein the processor is further configured with processor-executable instructions to take an action in response to detecting an anomaly in one or more rotors selected from a group consisting of:
preventing the aerial robotic vehicle from lifting-off;
limiting operations of the aerial robotic vehicle within certain performance limits; and
issuing a maintenance alert by the processor.

24. The aerial robotic vehicle of claim 20, wherein the processor is further configured with processor-executable instructions to determine whether the aerial robotic vehicle is airworthy enough to perform a flight plan in response to detecting an anomaly in one or more rotors.

25. The aerial robotic vehicle of claim 20, wherein the processor is further configured with processor-executable instructions to determine whether the aerial robotic vehicle is airworthy enough for current flight conditions.

26. The aerial robotic vehicle of claim 20, wherein the processor is further configured with processor-executable instructions to take an action in response to detecting an anomaly in one or more rotors by:
re-configuring a flight parameter of the aerial robotic vehicle.

27. The aerial robotic vehicle of claim 26, wherein the processor is further configured with processor-executable instructions such that re-configuring the flight plan comprises adding, removing, or modifying a waypoint in the flight plan.

28. The aerial robotic vehicle of claim 20, wherein the processor is further configured with processor-executable instructions such to obtain data related to at least one of a physical condition of the rotors that may be observed visually and how the rotors operate while spinning.

29. An aerial robotic vehicle, comprising:
means for obtaining data regarding anomalies in rotors of the aerial robotic vehicle;
means for determining whether an anomaly is detected in any rotor based on the obtained data; and
means for taking an action in response to detecting an anomaly in one or more rotors.

30. A processing device configured for use in an aerial robotic vehicle and configured to:
obtain data from a sensor onboard the aerial robotic vehicle configured to detect anomalies in rotors thereof;
determine whether an anomaly is detected in any rotor based on the obtained data; and
take an action in response to detecting an anomaly in one or more of the rotors.
